(19) United States
(12) Patent Application Publication
(10) Pub. No.: US 2008/0318026 A1
(43) Pub. Date: Dec. 25, 2008

(54) METHOD OF MODIFYING CARBON NANOMATERIALS, COMPOSITES INCORPORATING MODIFIED CARBON NANOMATERIALS AND METHOD OF PRODUCING THE COMPOSITES

(75) Inventors: Liming Dai, Beavercreek, OH (US); Wei Chen, New York, NY (US); Zheng Rong Xu, Sugar Land, TX (US); Frank Espinosa, Girton (GB)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: UNIVERSITY OF DAYTON, Dayton, OH (US)

(21) Appl. No.: 11/767,909

(22) Filed: Jun. 25, 2007

(51) Int. Cl. B32B 5/16; B32B 17/10; C08J 7/18

(52) U.S. Cl. 428/323; 428/339; 427/491; 977/742; 977/734; 977/753; 977/773; 977/778; 977/779; 977/788; 977/847; 977/902

(57) ABSTRACT

A polymer-carbon nanomaterial composite. The composite includes a polymer matrix; and plasma-modified carbon nanomaterials having surface functional groups attached thereto, wherein the carbon nanomaterial is selected from carbon nanotubes, carbon nanofibers, carbon nanoparticles, carbon black, nanodiamond, fullerenes, or combinations thereof. The invention also involves a method of making a polymer-carbon nanomaterial composite, and a method of modifying carbon nanomaterials.

### BACKGROUND OF THE INVENTION

The present invention relates to a method of carbon nanomaterial modification by plasma treatment, to composites which incorporate the plasma modified carbon nanomaterial, and to methods of producing those composites.

Carbon nanotubes (CNTs) have excellent mechanical properties, which make them attractive candidates for application in high performance composite materials. It is known that CNTs could have a Young's modulus of up to 1 TPa and a tensile strength approaching 60 GPa. The use of carbon nanotubes in many polymer/CNT composites, including poly(methyl methacrylate), epoxy resin, poly(vinyl alcohol) and polystyrene, has increased the mechanical properties of the composites, such as Young's modulus, hardness, and tensile strength.

In order to obtain good physical properties for CNT/polymeric composites, the surface of CNTs needs be modified to improve the nanotube dispersion and to enhance the interfacial strength. The existing technique for nanotube surface modification, oxidation of CNTs, has some disadvantages. The acid oxidation of CNTs will often destroy the structures of CNTs, add more defects on the surface of CNTs, and cut the CNTs into shorter fragments. The interfacial properties of the acid-oxidized carbon nanotubes can be improved by subsequent chemical modification through reactions characteristic of acid-oxidization-induced carboxylic groups. However, this requires complicated chemical processes which are often carried out in toxic solvents, and it increases both the cost for final products and the risk of environmental pollution.

Accordingly, there is a need for improved methods for surface modification of carbon nanomaterials, for improved composites, and for methods of making the composites.

### SUMMARY OF THE INVENTION

The present invention meets this need by providing a polymer-carbon nanomaterial composite. The composite includes a polymer matrix; and plasma-modified carbon nanomaterials having surface functional groups attached thereto, wherein the carbon nanomaterial is selected from carbon nanotubes, carbon nanofibers, carbon nanoparticles, carbon black, nanodiamond, fullerenes, or combinations thereof.

Another aspect of the invention is a method of making a polymer-carbon nanomaterial composite. The method includes providing carbon nanomaterials selected from carbon nanotubes, carbon nanofibers, carbon nanparticles, carbon black, nanodiamond, fullerenes, or combinations thereof; exposing the carbon nanomaterial to a plasma in the presence of a monomer to form plasma-modified carbon nanomaterial having surface functional groups attached thereto; providing a polymer matrix; and blending the plasma-modified carbon nanomaterial with the polymer matrix.

Another aspect of the invention is a method of modifying carbon nanomaterials. The method includes providing carbon nanomaterials selected from carbon nanotubes, carbon nanofibers, carbon nanparticles, carbon black, nanodiamond, fullerenes, or combinations thereof; and exposing the carbon nanomaterial to a plasma in the presence of a monomer to form plasma-modified carbon nanomaterial having surface functional groups attached thereto.

### BRIEF DESCRIPTION OF THE DRAWINGS

FIGS. 1A-1C shows the XPS spectra for the as-synthesized CNTs.

FIGS. 2A-2C shows the XPS spectra for acetic acid treated CNTs.

FIG. 3 is a graph showing the stress v. weight % of CNTs for rubber/CNT composites.

FIG. 4 is a graph showing the elongation at break v. weight % of CNTs for rubber/CNT composites.

FIG. 5 is a graph showing the tensile strength at break v. weight % of CNTs for rubber/CNT composites.

FIGS. 6A-6B are graphs showing the storage modulus and loss modulus v. temperature for rubber/CNT composites.

FIGS. 7A-7C are graphs showing the tensile properties of rubber/CNT composites,

FIGS. 8A-8B are graphs showing the storage modulus and loss modulus v. temperature for rubber/CNT composites.

FIGS. 9A-9C are graphs showing the tensile properties of rubber/CNT composites.

FIGS. 10A-10B are graphs showing the storage modulus and loss modulus v. temperature for rubber/CNT composites.

FIG. 11 is a graph showing the tensile strength at break v. weight % CNTs for rubber/CNT composites.

FIG. 12 is a graph showing elongation at break v. weight % CNTs for rubber/CNT composites.

FIGS. 13A-13B are graphs showing the tensile properties of rubber/CNT composites.

FIGS. 14A-14B are graphs showing the storage modulus and loss modulus v. temperature for rubber/CNT composites.

### DETAILED DESCRIPTION OF THE INVENTION

Plasma treatments for surface modification of carbon nanotubes in a dry state were developed. Interactions between the plasma-modified carbon nanotubes and polymeric matrices depend on the nature of functional groups induced by the plasma treatment. In order to develop polymeric/CNT composites with enhanced mechanical properties, the plasma-induced functional groups need to have strong interactions with the polymeric chains and/or other fillers in the polymeric matrix.

Although the examples describe the use of carbon nanotubes, the invention is not so limited. Other carbon nanomaterials, including, but not limited to carbon nanofibers, carbon nanoparticles, carbon black, nanodiamond, and fullerenes, can also be used.

The surface modified CNTs do not have a harmful effect(s) on their morphological structures. The modified CNTs can be used as enforcement fillers in polymeric materials, especially rubbers. The plasma treated CNTs with surface functional groups can be dispersed well in the rubber matrices, such as hydrogenated nitrile butadiene rubber (HNBR) and fluoroelastomers, to form rubber/CNT composites by conventional melting blending methods, including extrusion, roll milling, and solvent method. The polymer/CNT composites possess improved mechanical properties.

The surfaces of CNTs are modified in a plasma reactor, in which functional groups from plasma monomer vapor(s) are grafted onto the nanotube surfaces. The plasma monomers used in this study include, but are not limited to, acetic acid, hexane, acetonitrile, acrylic acid, methacrylic acid, and acetaldehyde. Suitable functional groups include, but are not limited to, acetic acid groups, hexane groups, acetonitrile groups, acrylic acid groups, methacrylic acid groups, acetaldehyde groups, alkyl amine groups, alcohol groups, or combinations thereof.

Suitable materials for the polymer matrix include, but are not limited to, rubbers, elastomers, thermoplastics, thermosets, synthetic inorganic polymers, biopolymers, coordination polymers, or combinations thereof. Suitable rubber matrix materials include, but are not limited to, hydrogenated nitrile butadiene rubber, styrene butadiene rubber, acrylonitrile butadiene styrene or combinations thereof. Suitable elastomer matrix materials include, but are not limited to, fluoroelastomers, ethylene propylene rubber, or combinations thereof. Suitable thermoplastic matrix materials include, but are not limited to, poly(vinyl acetate), ethylene vinyl acetate, polyacrylonitrile, polyethylene, polypropylene, or combinations thereof. Suitable thermoset matrix materials include, but are not limited to, urea-formaldehyde, epoxy, melamine, or combinations thereof.

The plasma-modified carbon nanomaterials are generally present in an amount of less than about 8 wt %, alternatively less than 6 wt %, alternately less than about 4 wt %, alternatively less than about 2 wt %, or alternatively less than about 1 wt %.

The polymer-carbon nanomaterial composite generally has at least one improved mechanical property compared to the polymer matrix without the plasma-modified carbon nanomaterial. Improved mechanical properties include, but are not limited to, elongation, tensile strength, storage modulus, loss modulus, or stress.

The polymer-carbon nanomaterial composite can be used to make a wide variety of products. Examples include, but are not limited to, inflatable packers, mechanical packers, plugs, cup packers, electrical cables, conductive cables, wirelines, o-rings, bonded seals, seal backup rings, motors, casing/tubing patches, cementing plugs, bottom plugs, shock/impact absorbers, or pump protectors.

The polymer-carbon nanomaterial composite can be made by exposing carbon nanomaterial to a plasma in the presence of a monomer to form plasma-modified carbon nanomaterial having surface functional groups attached thereto. The plasma-modified carbon nanomaterial is blended with the polymer matrix.

Suitable methods for blending the plasma-modified carbon nanomaterial with the polymer matrix include, but are not limited to, by melt blending, or mechanical mixture. Suitable melt blending methods include, but are not limited to, extrusion, roll milling, solvent method, or combinations thereof.

The carbon nanomaterial is typically exposed to the plasma for a time in the range of about 10 sec to about 2 hr, alternatively about 10 sec to about 15 min. The pressure is typically in the range of about 10 to about 30 mTorr. The vapor pressure of the monomer is typically in a range from about 50 mTorr to about 1,000 mTorr, alternatively about 50 mTorr to about 500 mTorr.

The invention may be more readily understood from the following examples, which are intended to illustrate the invention, but not limit the scope thereof.

### Example 1

### Plasma Treatment

The plasma treatment of carbon nanotubes was carried out under different chemical vapors (alkyl amines, alcohols, aldehyde, acetonitrile, acetic acid, and hexane) with a base pressure of 20 mTorr and monomer vapor pressure ranging from 50 to 1000 mTorr for 10 sec to 2 h.

### A) CNTs Before Plasma Treatment

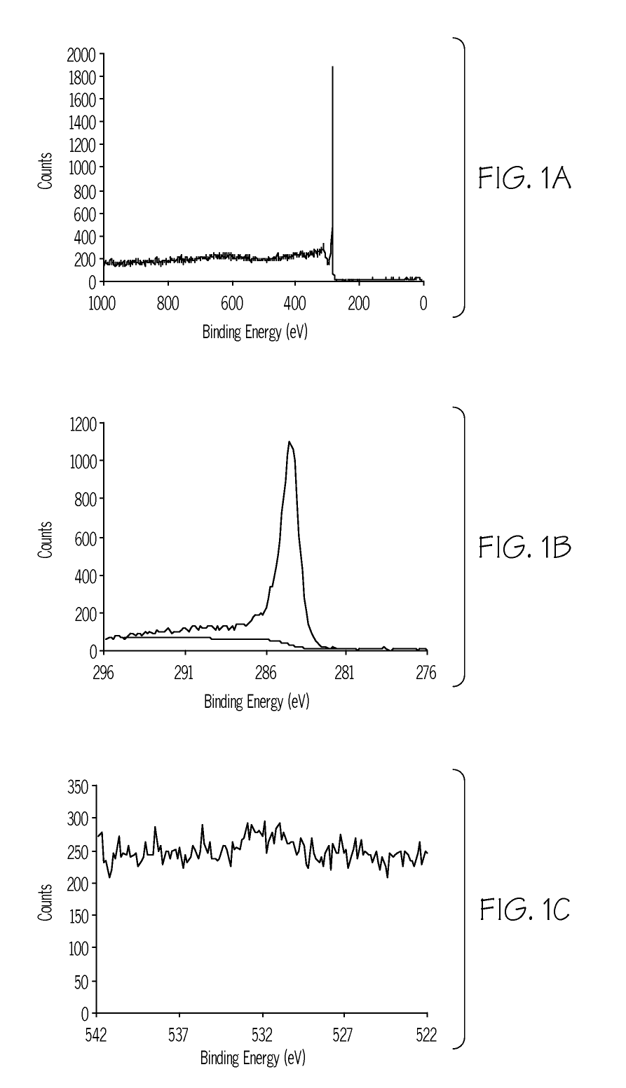

The XPS (X-ray photoelectron spectroscopy) survey spectrum of the raw CNTs (FIG. 1A) shows a carbon peak only. The high resolution C 1s spectrum (FIG. 1B) gives a graphite-like carbon peak while the corresponding high resolution O 1s spectrum (FIG. 1C) shows almost no detectable oxygen signal within the experimental error.

### B) CNTs After Acetic Acid Plasma Treatment

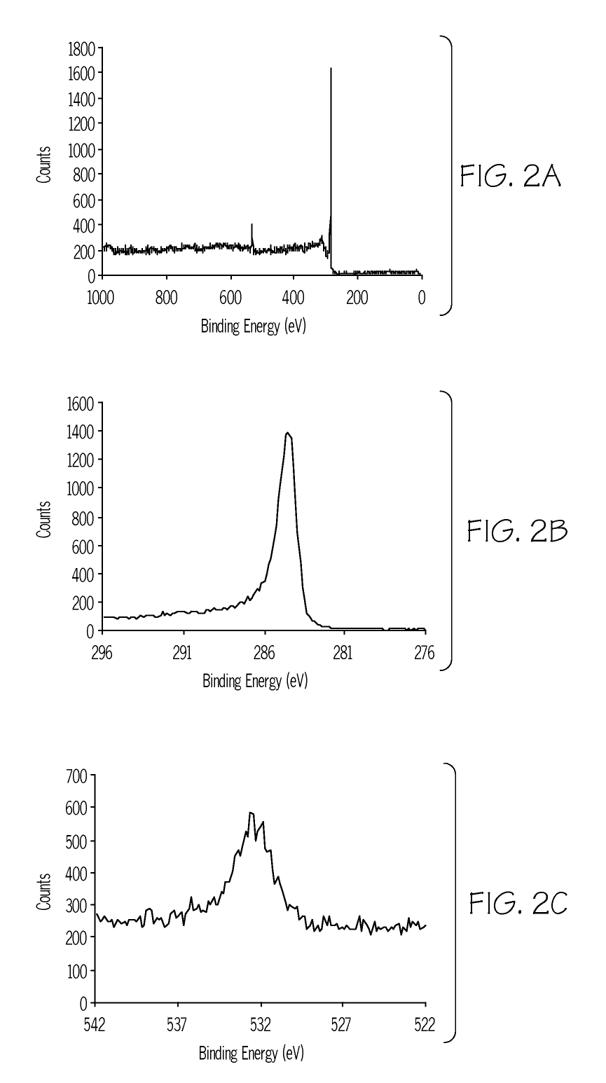

After the plasma treatment with acetic acid vapor at 100 mTorr for 10 s, the XPS survey spectrum of the plasma-modified CNTs (FIG. 2A) shows both oxygen and carbon peaks. The percentage content of C and O atoms in the acetic acid plasma treated CNTs were calculated from the high resolution C 1s (FIG. 2B) and O 1s (FIG. 2C) spectra to be 93% and 7%, respectively.

### Example 2

### Hydrogenated Nitrile Butadiene Rubber and Multi-Wall Carbon Nanotube (HNBR/MWNT) Composites

A desired amount of the acetic acid or hexane plasma-treated CNTs was mixed with a predetermined amount of raw HNBR sample in an extruder at 160° C. for 10 min before being extruded out. The crosslinking initiator was added to the HNBR/carbon nanotube mixture and blended at 100° C. for another 10 min. The mixture sample was pressed at 176° C. (350° F.) for 20 min to crosslink in a sheet form.

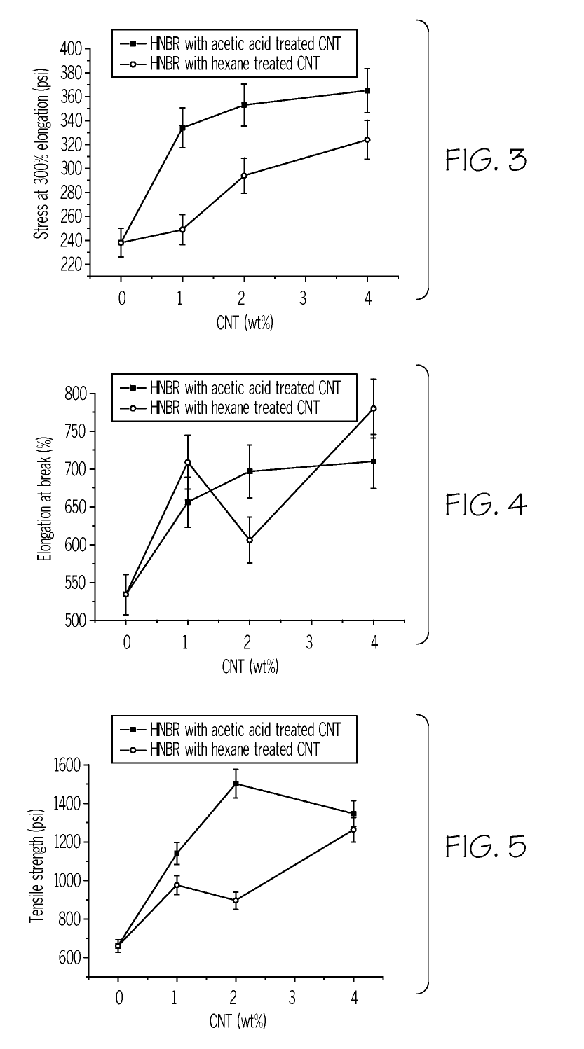

As shown in FIG. 3, the composite with 4 wt % acetic acid plasma-treated carbon nanotubes had a stress of 365 psi at 300% strain, which is 53% higher than the control sample (i.e., 0% CNTs). With 1 wt % acetic acid plasma-treated carbon nanotubes, the stress of the composite increased to 334 psi. Overall, the samples with acetic acid plasma-treated carbon nanotubes had better mechanical properties than those of the hexane plasma-treated carbon nanotubes. This is presumably because the plasma-induced acetic acid groups show a better compatibility with the HNBR chains and/or silica fillers due to the hydrophilic-hydrophilic interaction with respect to the hexane-plasma treated CNT surface.

As shown in FIGS. 4 and 5, all the composite samples showed a longer elongation and higher tensile strength at break in comparison with the control sample. For example, pure HNBR had a tensile strength of 661 psi at break whereas the composite sample with a 2 wt % loading of the acetic acid plasma-treated CNTs showed a tensile strength of 1503 psi at break. Both the elongation and tensile strength of the HNBR sample increased by adding the plasma-treated CNTs.

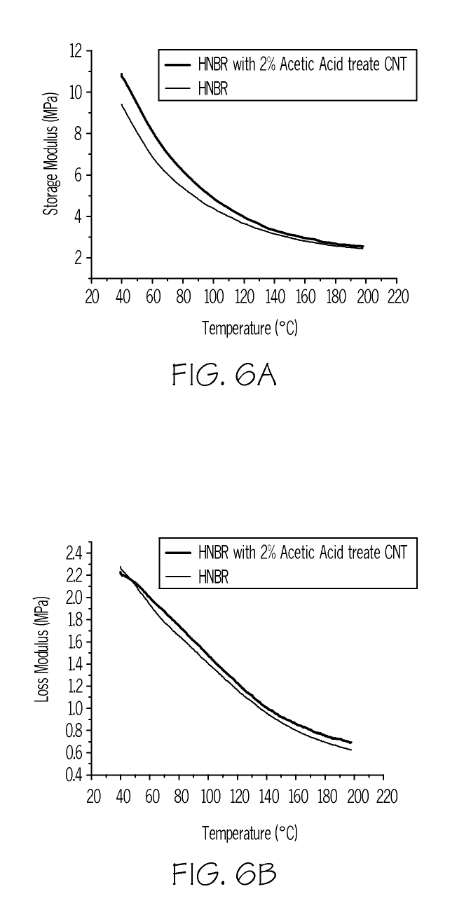

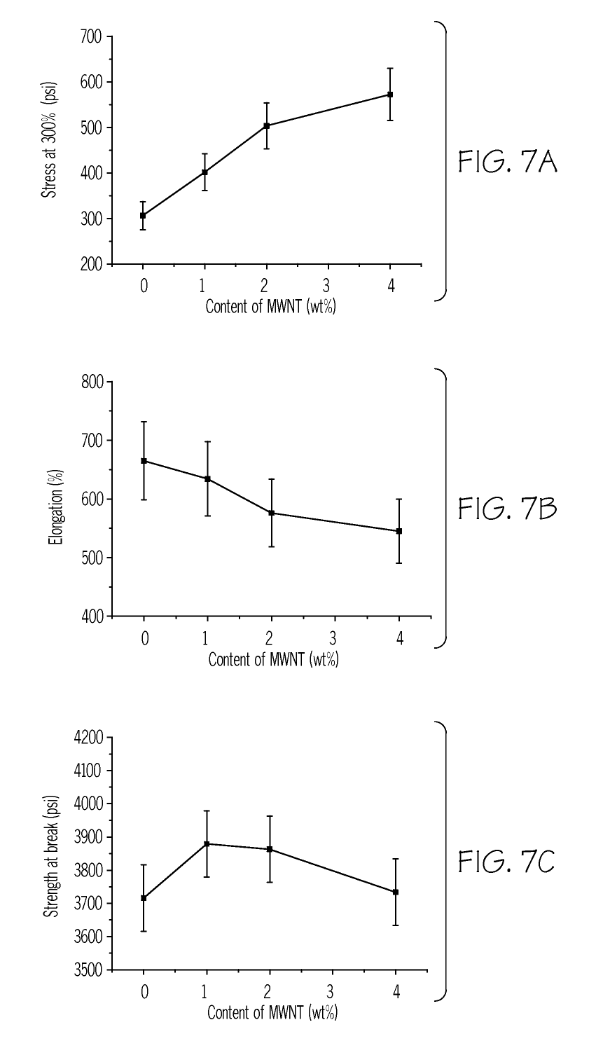

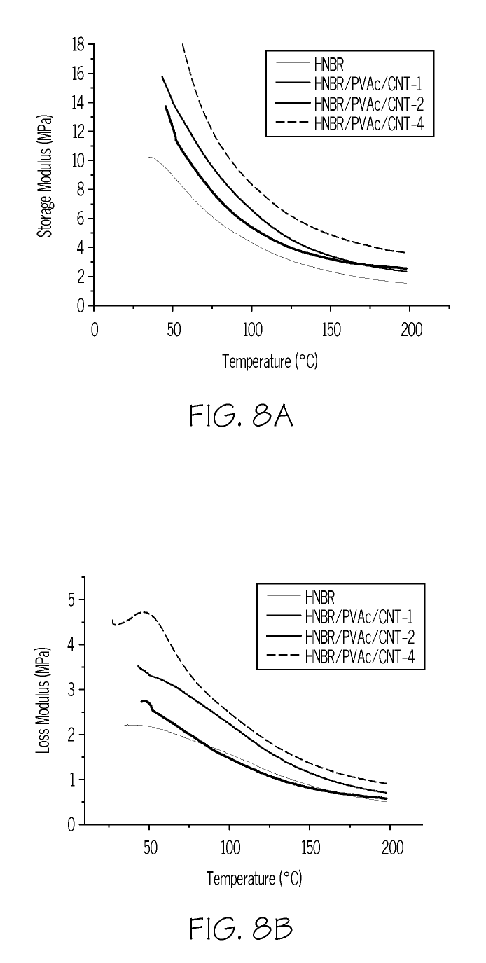

FIG. 6 shows the dynamic mechanic analysis (DMA) of the HNBR composite compared to pure HNBR. The HNBR composite sample with 2 wt % acetic acid plasma-treated CNTs showed a higher storage modulus than the pure HNBR over a wide range temperature from 40° C. to 200° C., although this enhancement became less significant above 150° C. (FIG. 6A). A storage modulus of 10.7 MPa at 40° C. was observed, which is 1.4 MPa higher than that of the pure HNBR sample. Similarly, the loss modulus of the HNBR/MWNT composite was also higher than that of the pure HNBR over the temperature range used for the measurements, as shown in FIG. 6B.

### Example 3

### HNBR/Poly(vinyl acetate) (PVAc)/MWNTs

A desired amount of the acetic acid plasma-treated carbon nanotubes was mixed with 10 wt % PVAc in N,N-dimethyl formamide with a ratio of 1:1 by weight, followed by sonication at room temperature for 1 h. The solvent was evaporated under vacuum at 80° C., and the solid residue was further dried in oven at 80° C. for 48 h to produce the PVAC/MWNT mixture. A desired amount of the PVAc/MWNT mixture was added into a HNBR sample in an extruder at 160° C. for 10 min and extruded out. Weight ratios of the MWNT/HNBR in the resulting samples are 1/100, 2/100 and 4/100 (designated as: HNBR/PVAc/CNT-x, where x is the weight ratio of MWNT to HNBR). The crosslinking initiator was added to the MWNT/HNBR mixture at 100° C. for 10 min. The samples were pressed at 176° C. (350° F.) for 20 min to crosslink in a sheet form. The control sample was the raw HNBR crosslinked using the above procedure with the crosslinking initiator, but without CNTs.

As seen in FIG. 7A, all of the composites showed increased stresses compared to the pure HNBR sample. For example, the composite with 4 wt % acetic acid plasma-treated carbon nanotubes had a stress of 572 psi at 300% strain, which is 87% higher than that of the pure HNBR sample (306 psi). Even with 1 wt % acetic acid plasma-treated carbon nanotubes, the stress of the composite increased to 401 psi at 300% strain. However, as shown in FIG. 7B, the elongation at break of the HNBR/PVAc/CNT composite samples decreased marginally from 665% to 545% with the increase in CNT loadings. The strength at break for the HNBR/PVAc/CNT composite samples was largely unchanged (within the experimental error), at about 3800 psi, which is characteristic of the pure HNBR sample, as shown in FIG. 7C.

The storage modulus and loss modulus of the HNBR/PVAc/CNT composite samples increased in comparison with pure HNBR at high temperature (FIGS. 8A and B). For example, the storage modulus of HNBR/PVAc/CNT-4 sample was 3.4 MPa, while that of the pure HNBR sample was 1.4 MPa at 200° C. (FIG. 8A).

### Example 4

### HNBR/Ethylene-vinyl acetate Copolymer (EVA)/MWNT

A desired amount of the acetic acid plasma-treated carbon nanotubes was mixed with 10 wt % EVA in an extruder at 180° C. for 10 min and extruded out. A predetermined amount of the EVA/MWNT mixture was added into the HNBR sample in an extruder at 180° C. for 10 min and extruded out. Weight ratios of MWNT/HBNR in the resulting samples are 1/100, 2/100 and 4/100 (designated as: HNBR/PVAc/CNT-x, where x is the weight ratio of MWNT to HNBR). The crosslinking initiator was added to the HNBR/PVAc/CNT mixture at 140° C. for 10 min. The resultant samples were pressed at 176° C. (350° F.) for 20 min to crosslink in a sheet form. The control sample was the raw HNBR sample crosslinked by above procedure with the crosslinking initiator, but without CNTs.

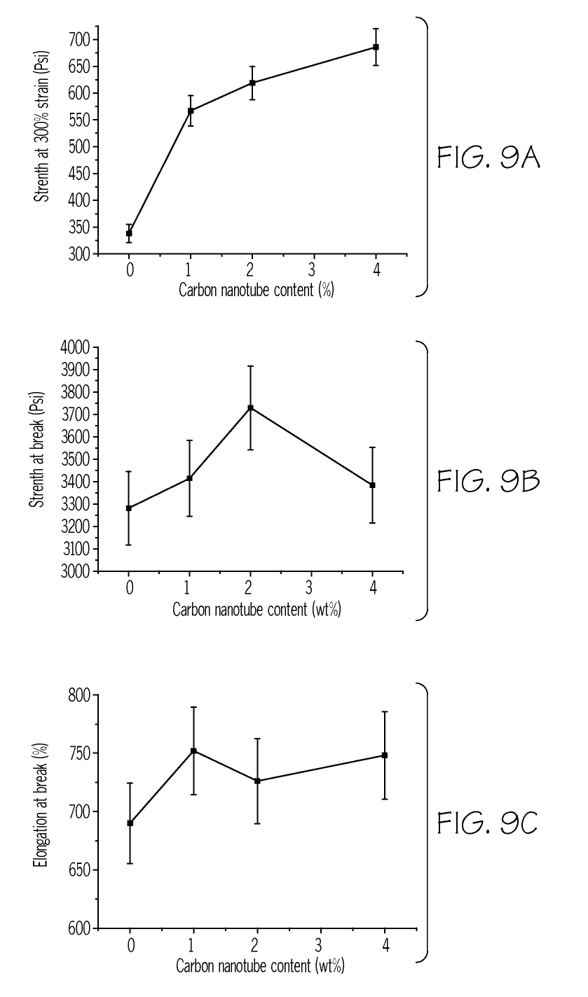

As seen in FIG. 9, all of the composites showed increased stresses compared to the pure HNBR sample. For example, the composite with 4 wt % acetic acid plasma-treated carbon nanotubes had a stress of 686 psi at 300%, which was about 100% higher than that of the HNBR sample (338 psi) (FIG. 9A). Even with 1 wt % acetic acid treated carbon nanotubes, the modulus of the composite increased to 567 psi. The strength at break also showed some enhancement (FIG. 9B). For instance, with 2 wt % acetic acid plasma-treated CNTs in the HNBR/EVA/MWNT composite, the strength at break was 3729 psi, while it was 3281 psi for the raw HNBR. In other words, the strength at break of the HNBR/EVA/MWNT-2 was about 14% higher than that of the raw HNBR. Even with 1 wt % acetic acid plasma-treated CNTs in the HNBR/EVA/MWNT composite, the strength at break increased to 3414 psi from 3281 psi of raw HNBR. However, with 4 wt % acetic acid plasma-treated CNTs in the composite (HNBR/EVA/MWNT-4), the strength at break was lower than that of HNBR/EVA/MWNT-2. The elongation at break for HNBR/EVA/MWNT composites was largely unchanged (within the experimental error) (FIG. 9C) at about 700%, which is characteristic of the pure HNBR sample.

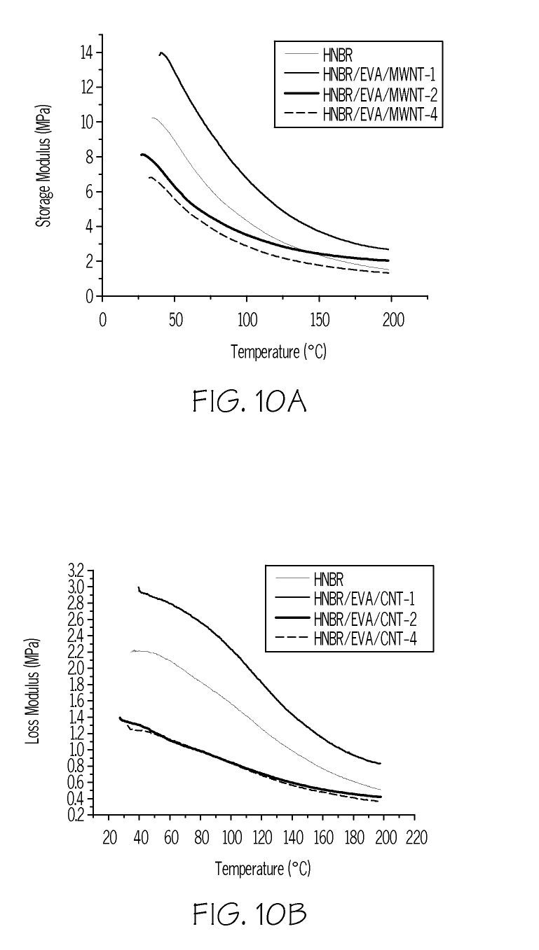

FIG. 10 shows enhanced storage modulus and loss modulus for HNBR/EVA/MWNT-1 at elevated temperature. For example, as shown in FIG. 10A, the storage modulus of the HNBR/EVA/MWNT-1 composite sample was 2.68 MPa at 200° C., which was about 76% higher than that of the raw HNBR (1.52 MPa). Although the storage modulus of HNBR/EVA/MWNT-2 was lower than that of the raw HNBR below 150° C., it was slightly higher than that of the raw HNBR above 150° C. For example, the storage modulus of HNBR/EVA/MWNT-2 was 2.06 MPa at 200° C., which was about 35% higher than that of the raw HNBR. However, the sample with a higher loading of carbon nanotubes (HNBR/EVA/MWNT-4) had a lower storage modulus in the whole range from ambient temperature to 200° C. All the composites samples had a lower loss modulus with respect to the raw HNBR except the HNBR/EVA/MWNT-1 composite sample, which had a much higher loss modulus over the whole temperature range below 200° C. (FIG. 10B).

### Example 5

### Fluoroelastomer/MWNT

A desired amount of the plasma-treated carbon nanotubes was mixed with fluoroelastomer (VTR 8655, or GBL 6005, available from Schlumberger) sample at 170° C. for 10 min. and then extruded out. Weight ratios of the plasma treated MWNT/fluoroelastomer are 1/100, 2/100, and 4/100 (designated as: fluoroelastomer/CNT-x, where x is the weight ratio of MWNT to HNBR). The crosslinking initiator (A178 Luperco and A317 Taic DLC, available from Schlumberger) was added to the MWNT/fluoroelastomer mixture at 110° C. for 10 min. The weight ratio of A178/A317/fluoroelastomer was 3.3/1.9/100. The resultant sample was pressed at 180° C. for 30 min to crosslink in a sheet form. The control sample was made using the above procedure, but without carbon nanotubes.

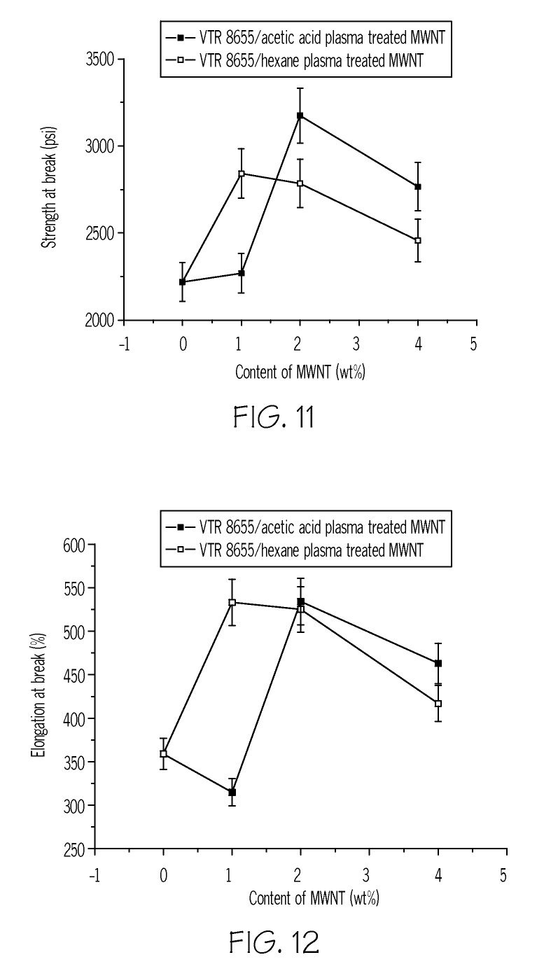

As shown in FIG. 11, with 1 wt % acetic acid plasma-treated MWNT, the strength at break of the composite sample was about the same as the pure fluoroelastomer VTR 8655. With 2 wt % acetic acid plasma-treated MWNTs, the strength at break of the composite sample increased to 3174 psi (from 2218 psi for the pure VTR 8655 fluoroelastomer). With 4 wt % acetic acid plasma-treated MWNTs, the strength at break dropped to 2766 psi. The tensile properties of the VTR 8655 fluoroelastomer/MWNT composites reached the maximum with 2 wt % content of the acetic acid plasma-treated MWNT.

For the hexane plasma-treated MWNTs, the VTR 8655 fluoroelastomer/MWNT composites also showed an enhanced strength at break, even with 1 wt % loading of the hexane plasma-treated MWNTs in the rubber matrix. Further increase in the loading of the hexane plasma-treated MWNTs (4 wt %) caused the strength at break to slightly decrease within the experimental error (FIG. 11).

As shown in FIG. 12, the addition of up to 1 wt % acetic acid plasma-treated MWNTs did not cause any significant change in the elongation at break for the VTR 8655 fluoroelastomer within the experimental error. However, the same composite sample with 2 wt % acetic acid plasma-treated MWNTs had a much higher elongation at break (535%) than that of the pure VTR 8655 sample (360%). Further increase in the loading of acetic acid plasma-treated MWNTs caused a significant decrease in the elongation at break to 463% with 4 wt % acetic acid plasma-treated MWNTs. In case of VTR 8655 fluoroelastomer/MWNT composites with the hexane plasma-treated MWNTs, the longest elongation at break (about 530%) was reached by the samples with 1-2 wt % hexane plasma-treated MWNTs. The elongation at break of the VTR 8655 fluoroelastomer composites decreased with further increase in the content of the hexane-plasma treated MWNTs (4 wt %).

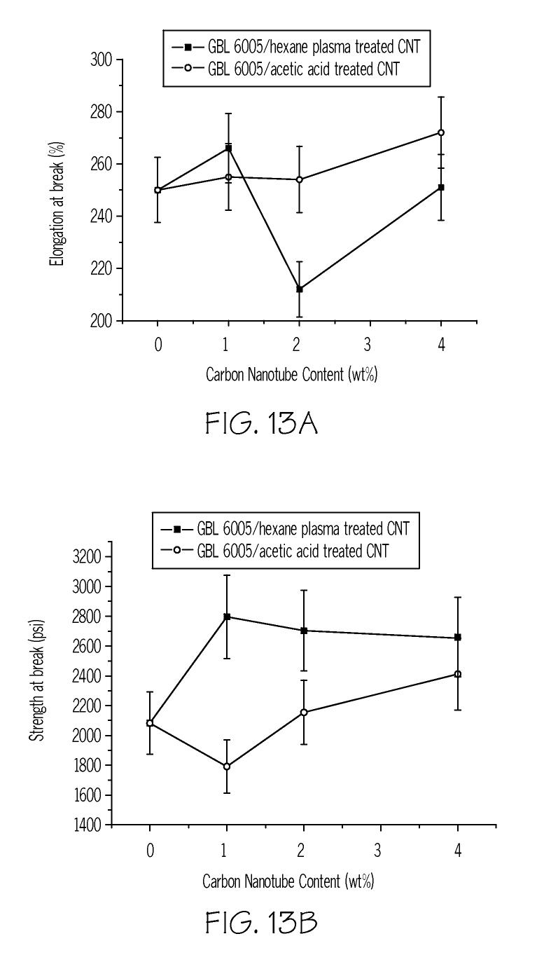

As shown in FIG. 13A, all the samples of GBL 6005 and its composites with the acetic acid plasma-treated CNTs had a similar elongation at break of about 250%. The strength at break for the GBL 6005/MWNT composites with 1 wt % acetic acid plasma-treated MWNTs increased to 2796 psi from 2083 psi for the pure GBL 6005, as shown in FIG. 13B. The composite samples with a higher content of the acetic acid plasma-treated MWNTs showed a similar strength at break as that of the same composite with 1 wt % acetic acid plasma-treated MWNTs within the experimental error (2703 psi for the sample with 2 wt % MWNTs; 2660 psi for the sample with 1 wt % MWNTs).

For the GBL 6005/MWNT composites with the hexane plasma-treated MWNTs, only the composite sample with 4 wt % hexane plasma-treated MWNTs showed an enhanced strength at break of 2412 psi. With the load of the hexane plasma-treated MWNTs below 4 wt %, the strength at break of the composite samples was similar to the of the pure GBL 6005 sample.

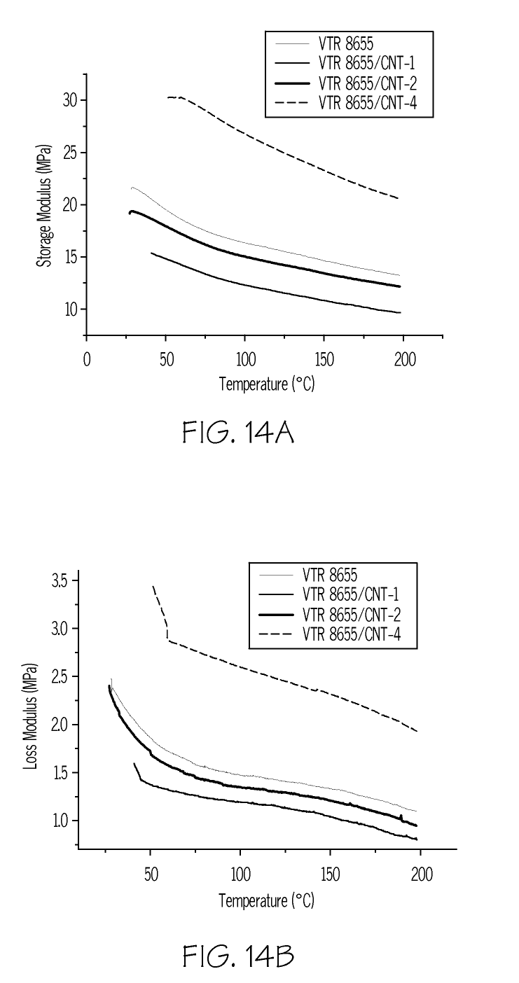

As shown in FIG. 14A, the VTR 8655/CNT-4 composite samples showed enhanced storage modulus over the whole temperature range (50-200° C.) compared to the pure VTR 8655 sample. The VTR 8655/CNT-1 and VTR 8655/CNT-2 composite samples possessed a decreased storage modulus. The loss modulus of the VTR 8655/CNT composites showed a same trend as the storage modulus, as shown in FIG. 14B.

While certain representative embodiments and details have been shown for purposes of illustrating the invention, it will be apparent to those skilled in the art that various changes in the apparatus and methods disclosed herein may be made without departing from the scope of the invention.

What is claimed is:

1. A polymer-carbon nanomaterial composite comprising:
a polymer matrix; and
plasma-modified carbon nanomaterials having surface functional groups attached thereto, wherein the carbon nanomaterial is selected from carbon nanotubes, carbon nanofibers, carbon nanoparticles, carbon black, nanodiamond, fullerenes, or combinations thereof.

2. The polymer-carbon nanomaterial composite of claim 1 wherein the functional groups are selected from acetic acid groups, hexane groups, acetonitrile groups, acrylic acid groups, methacrylic acid groups, acetaldehyde groups, alkyl amine groups, alcohol groups, or combinations thereof.

3. The polymer-carbon nanomaterial composite of claim 1 wherein the polymer matrix is selected from rubbers, elastomers, thermoplastics, thermosets, synthetic inorganic polymers, biopolymers, coordination polymers, or combinations thereof.

4. The polymer-carbon nanomaterial composite of claim 3 wherein the polymer matrix is a rubber matrix selected from hydrogenated nitrile butadiene rubber, styrene butadiene rubber, acrylonitrile butadiene styrene, or combinations thereof.

5. The polymer-carbon nanomaterial composite of claim 3 wherein the polymer matrix is an elastomer matrix selected from fluoroelastomers, ethylene propylene rubber, or combinations thereof.

6. The polymer-carbon nanomaterial composite of claim 3 wherein the polymer matrix is a thermoplastic matrix selected from poly(vinyl acetate), ethylene vinyl acetate, polyacrylonitrile, polyethylene, polypropylene, or combinations thereof.

7. The polymer-carbon nanomaterial composite of claim 3 wherein the polymer matrix is a thermoset matrix selected from urea-formaldehyde, epoxy, melamine, or combinations thereof.

8. The polymer-carbon nanomaterial composite of claim 1 wherein the plasma-modified carbon nanomaterial is present in an amount of less than about 8 wt %.

9. The polymer-carbon nanomaterial composite of claim 1 wherein the polymer-carbon nanomaterial composite has at least one improved mechanical property compared to the polymer matrix without the plasma-modified carbon nanomaterial.

10. The polymer-carbon nanomaterial composite of claim 9 wherein the improved mechanical property is selected from elongation, tensile strength, storage modulus, loss modulus, or stress.

11. A product made from the polymer-carbon nanomaterial composite of claim 1.

12. The product of claim 11 wherein the product is selected from inflatable packers, mechanical packers, plugs, cup packers, electrical cables, conductive cables, wirelines, o-rings, bonded seals, seal backup rings, motors, casing/tubing patches, cementing plugs, bottom plugs, shock/impact absorbers, or pump protectors.

13. A method of making a polymer-carbon nanomaterial composite comprising:
providing carbon nanomaterials selected from carbon nanotubes, carbon nanofibers, carbon nanparticles, carbon black, nanodiamond, fullerenes, or combinations thereof;
exposing the carbon nanomaterial to a plasma in the presence of a monomer to form plasma-modified carbon nanomaterial having surface functional groups attached thereto;
providing a polymer matrix; and
blending the plasma-modified carbon nanomaterial with the polymer matrix.

14. The method of claim 13 wherein the plasma-modified carbon nanomaterial is blended with the polymer matrix by melt blending.

15. The method of claim 14 wherein the melt blending is selected from extrusion, roll milling, solvent method, or combinations thereof.

16. The method of claim 13 wherein the polymer matrix is selected from rubbers, elastomers, thermoplastics, thermosets, synthetic inorganic polymers, biopolymers, coordination polymers, or combinations thereof.

17. The method of claim 16 wherein the polymer matrix is a rubber matrix selected from hydrogenated nitrile butadiene rubber, styrene butadiene rubber, acrylonitrile butadiene styrene, or combinations thereof.

18. The method of claim 16 wherein the polymer matrix is an elastomer matrix selected from fluoroelastomers, ethylene propylene rubber, or combinations thereof.

19. The method of claim 16 wherein the polymer matrix is a thermoplastic matrix selected from poly(vinyl acetate), ethylene vinyl acetate, polyacrylonitrile, polyethylene, polypropylene, or combinations thereof.

20. The method of claim 16 wherein the polymer matrix is a thermoset matrix selected from urea-formaldehyde, epoxy, melamine, or combinations thereof.

21. The method of claim 13 wherein the monomer is selected from acetic acid, hexane, acetonitrile, acrylic acid, methacrylic acid, acetaldehydes, alkyl amines, alcohols, or combinations thereof.

22. The method of claim 13 wherein the carbon nanomaterial is exposed to the plasma for a time in the range of about 10 sec to about 2 hr.

23. The method of claim 13 wherein the carbon nanomaterial is exposed to the plasma at a pressure in the range of about 10 to about 30 mTorr.

24. The method of claim 13 wherein a vapor pressure of the monomer is in a range from about 50 mTorr to about 1,000 mTorr.

25. A method of modifying carbon nanomaterials comprising:
providing carbon nanomaterials selected from carbon nanotubes, carbon nanofibers, carbon nanparticles, carbon black, nanodiamond, fullerenes, or combinations thereof; and
exposing the carbon nanomaterial to a plasma in the presence of a monomer to form plasma-modified carbon nanomaterial having surface functional groups attached thereto.

26. The method of claim 25 wherein the monomer is selected from acetic acid, hexane, acetonitrile, acrylic acid, methacrylic acid, acetaldehydes, alkyl amines, alcohols, or combinations thereof.

27. The method of claim 25 wherein the carbon nanomaterial is exposed to the plasma for a time in the range of about 10 sec to about 2 hr.

28. The method of claim 25 wherein the carbon nanomaterial is exposed to the plasma at a pressure in the range of about 10 to about 30 mTorr.

29. The method of claim 25 wherein a vapor pressure of the monomer is in a range from about 50 mTorr to about 1,000 mTorr.
